(19) United States
(12) Patent Application Publication
(10) Pub. No.: US 2015/0103154 A1
(43) Pub. Date: Apr. 16, 2015

(54) DUAL AUDIO VIDEO OUTPUT DEVICES WITH ONE DEVICE CONFIGURED FOR THE SENSORY IMPAIRED

(71) Applicant: SONY CORPORATION, Tokyo (JP)

(72) Inventor: Brant Candelore, San Diego, CA (US)

(73) Assignee: SONY CORPORATION, Tokyo (JP)

(21) Appl. No.: 14/050,941

(22) Filed: Oct. 10, 2013

(51) Int. Cl. G09B 21/00; H04N 7/088; H04N 7/025; H04N 5/60

(52) U.S. Cl. CPC G09B 21/00; H04N 5/607; H04N 7/0882; G09B 21/002; G09B 21/008; G09B 21/009; H04N 7/0255
USPC 348/63; 348/62

(57) ABSTRACT

An apparatus includes at least one processor and at least one computer readable storage medium. The computer readable storage medium is accessible to the processor and bears instructions which when executed by the processor cause the processor to receive input representing visual, audio and/or cognitive capabilities of a first person and at least in part based on the input, configure at least a first setting on a first audio video output device. The instructions also cause the processor to present a first audio video presentation on the first audio video output device in accordance with the first setting, and concurrently with presenting the first audio video presentation on the first audio video output device, present the first audio video presentation on a companion audio video output device located in a common space with the first audio video output device.

### I. FIELD OF THE INVENTION

The present application relates generally to presenting audio video (AV) content on audio video output devices, with at least one of the devices configured to present the AV content in a format optimized for observance by a person with a sensory impairment.

### II. BACKGROUND OF THE INVENTION

It is often easier for the audibly and/or visually impaired to observe audio video (AV) content in a format tailored to their impairment to make the AV content more perceptible to them given their impairment. However, present principles recognize that two or more people may wish to simultaneously view the same content in the same room (e.g. in each other's presence) for a shared viewing experience, but only one person may have a hearing, visual, and/or cognitive impairment while the other may wish to view the AV content in its “normal,” non- impaired format.

### SUMMARY OF THE INVENTION

Accordingly, in a first aspect, an apparatus includes at least one processor and at least one computer readable storage medium that is not a carrier wave. The computer readable storage medium is accessible to the processor and bears instructions which when executed by the processor cause the processor to receive input representing visual or audible capabilities of a first person and at least in part based on the input, configure at least a first setting on a first audio video output device. The instructions also cause the processor to present a first audio video presentation on the first audio video output device in accordance with the first setting and concurrently with presenting the first audio video presentation on the first audio video output device, present the first audio video presentation on a companion audio video output device located in a common space with the first audio video output device.

Furthermore, in some embodiments the instructions when executed by the processor cause the processor to receive second input representing visual or audible capabilities of a second person and at least in part based on the second input, configure at least a second setting on the companion audio video output device. The instructions thus may also cause the processor to present the first audio video presentation on the companion audio video output device in accordance with the second setting. In some embodiments, the first setting may be an audio setting and/or a visual display setting.

If the first setting is a visual display setting, if desired it may be a first color blind setting while the second setting may be configured for presenting video from the first audio video presentation in a configuration not optimized for the visually impaired. Also in some embodiments, if the first setting is a visual display setting then it may be a first color blind setting while the second setting may be a second color blind different from the first color blind setting, where both the first and second color blind settings are thus configured for presentation of video from the first audio video presentation in configurations optimized for different visual capabilities.

Further still, in some embodiments the first setting may be a setting for closed captioning, and/or may be a visual display setting for magnifying images presented on the first audio video output device. Thus, e.g., at least one person included in at least one image presented on the first audio video output device may be magnified. Moreover, as indicated above, the first setting may be an audio display setting, and in such instances may pertain to volume output on the first audio video output device, audio pitch, and/or frequency.

In another aspect, a method includes providing audio video (AV) content to at least two AV display devices, where the AV content is configured for presentation on a first AV display device according to a first setting configured to optimize the AV content for observance by a person with a sensory impairment. The method also includes synchronizing presentation of the AV content on the first AV display device and a second AV display device, where presentation of the AV content is synchronized such that at least similar video portions of the AV content are presented on the first and second AV display devices at or around the same time.

In still another aspect, a computer readable storage medium bears instructions which when executed by a processor of a consumer electronics (CE) device configure the processor to execute logic including presenting at least video content on separate display devices concurrently, where the video content is presented on at least a first of the display devices in a first format not optimized for observance by the sensory impaired and the video content is presented on at least a second of the display devices in a second format optimized for observance by the sensory impaired.

In still another aspect, a computer readable storage medium bears instructions which when executed by a processor of a consumer electronics (CE) display device configure the processor to execute logic including providing at least video content on separate display devices concurrently, where the video content is presented on at least a first display device in a first format not optimized for observance by the sensory impaired and sending the video content from the first display device to a second display device for presentation thereon in a second format optimized for observance by the sensory impaired.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an exemplary system including two CE devices for providing AV content in accordance with present principles;

FIG. 2 is an exemplary flowchart of logic to be executed by a CE device to present an AV content in accordance with present principles;

FIG. 3 is an exemplary flowchart of logic to be executed by a server for providing AV content in accordance with present principles;

FIG. 4 is an exemplary diagram of two CE devices presenting AV content and a set top box providing the content, with the devices located in the same room of a personal residence in accordance with present principles;

FIG. 5 is an exemplary settings UI for configuring presentation of AV content in accordance with present principles; and

FIGS. 6-10 are exemplary UIs for selecting and viewing AV content in accordance with present principles.

### DETAILED DESCRIPTION OF THE PREFERRED EMBODIMENT

This disclosure relates generally to consumer electronics (CE) device based user information. With respect to any computer systems discussed herein, a system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software modules described by way of flow charts and/or user interfaces herein can include various sub-routines, procedures, etc. It is to be understood that logic divulged as being executed by a module can be redistributed to other software modules and/or combined together in a single module arid/ or made available in a shareable library.

Logic when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

In an example, a processor can access information over its input lines from data storage, such as the computer readable storage medium, and/or the processor accesses information wirelessly from an Internet server by activating a wireless transceiver to send and receive data. Data typically is converted from analog signals to digital and then to binary by circuitry between the antenna and the registers of the processor when being received and from binary to digital to analog when being transmitted. The processor then processes the data through its shift registers to output calculated data on output lines, for presentation of the calculated data on the CE device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

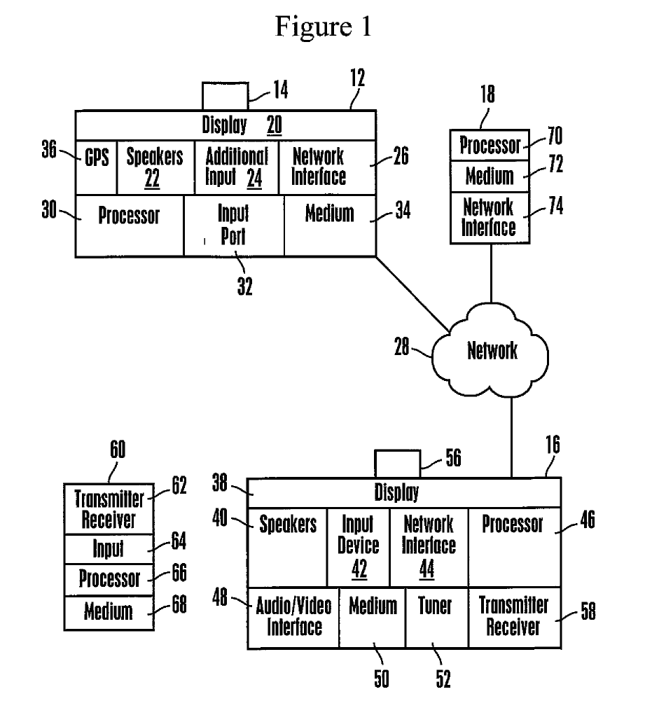

Now referring specifically to FIG. 1, an exemplary system 10 includes a consumer electronics (CE) device 12 that may be, e.g., a wireless telephone, tablet computer, notebook computer, etc., and second CE device 16 that in exemplary embodiments may be a television (TV) such as a high definition TV and/or Internet-enabled computerized (e.g. “smart”) TV, but in any case both the CE devices 12 and 16 are understood to be configured to undertake present principles (e.g. communicate with each other to facilitate simultaneous or near-simultaneous presentation of the same AV content on different devices as disclosed herein). Also shown in FIG. 1 is a server 18.

Describing the first CE device 12 with more specificity, it includes a touch-enabled display 20, one or more speakers 22 for outputting audio in accordance with present principles, and at least one additional input device 24 such as, e.g., an audio receiver/microphone for e.g. entering commands to the CE device 12 to control the CE device 12. The CE device 12 also includes a network interface 26 for communication over at least one network 28 such as the Internet, an WAN, an LAN, etc. under control of a processor 30, it being understood that the processor 30 controls the CE device 12 including presentation of AV content configured for the sensory impaired in accordance with present principles. Furthermore, the network interface 26 may be, e.g., a wired or wireless modern or router, or other appropriate interface such as, e.g., a Wi-Fi, Bluetooth, Ethernet or wireless telephony transceiver. In addition, the CE device 12 includes an input port 32 such as, e.g., a USB port, and a tangible computer readable storage medium 34 such as disk-based or solid state storage. In some embodiments, the CE device 12 may also include a GPS receiver 36 that is configured to receive geographic position information from at least one satellite and provide the information to the processor 30, though it is to be understood that another suitable position receiver other than a GPS receiver may be used in accordance with present principles.

Note that the CE device 12 also includes a camera 14 that may be, e.g., a thermal imaging camera, a digital camera such as a webcam, and/or camera integrated into the CE device 12 and controllable by the processor 30 to gather pictures/images and/or video of viewers/users of the CE device 12. As alluded to above, the CE device 12 may be e.g. a laptop computer, a desktop computer, a tablet computer, a mobile telephone, an Internet-enabled and/or touch-enabled computerized (e.g. “smart”) telephone, a PDA, a video player, a smart watch, a music player, etc.

Continuing the description of FIG. 1 with reference to the CE device 16, in the exemplary system 10 it may be a television (TV) such as e.g. an Internet-enabled computerized (e.g. “smart”) TV. Furthermore, the CE device 16 includes a touch enabled display 38, one or more speakers 40 for outputting audio in accordance with present principles, and at least one additional input device 42 such as, e.g., an audio receiver/microphone for entering voice commands to the CE device 16. The CE device 16 also includes a network interface 44 for communication over the network 28 under control of a processor 46, it being understood that the processor 46 controls the CE device 16 including presentation of AV content for the sensory impaired in accordance with present principles. The network interface 44 may be, e.g., a wired or wireless modem or router, or other appropriate interface such as, e.g., a Wi-Fi, Bluetooth, Ethernet or wireless telephony transceiver. In addition, the CE device 16 includes an audio video interface 48 to communicate with other devices electrically/communicatively connected to the TV 16 such as, e.g., a set-top box, a DVD player, or a video game console over, e.g., an HDMI connection to thus provide audio video content to the CE device 16 for presentation thereon.

The CE device 16 further includes a tangible computer readable storage medium 50 such as disk-based or solid state storage, as well as a TV tuner 52. In some embodiments, the CE device 16 may also include a GPS receiver (though not shown) similar to the GPS receiver 36 in in function and configuration. Note that a camera 56 is also shown and may be, e.g., a thermal imaging camera, a digital camera such as a webcam, and/or camera integrated into the CE device 16 and controllable by the processor 46 to gather pictures/images and/or video of viewers/users of the CE device 16, among other things.

In addition to the foregoing, the CE device 16 also has a transmitter/receiver 58 for communicating with a remote commander (RC) 60 associated with the CE device 16 and configured to provide input (e.g., commands) to the CE device 16 to control the CE device 16. Accordingly, the RC 60 also has a transmitter/receiver 62 for communicating with the CE device 16 through the transmitter/receiver 58. The RC 60 also includes an input device 64 such as a keypad or touch screen display, as well as a processor 66 for controlling the RC 60 and a tangible computer readable storage medium 68 such as disk-based or solid state storage. Though not shown, in some embodiments the RC 60 may also include a touch-enabled display screen, a camera such as one of the cameras listed above, and a microphone that may all be used for providing commands to the CE device 16 in accordance with present principles. E.g., a user may configure a setting (e.g. at the CE device 16) to present AV content to be presented thereon in a format configured for observation by a person with one or more sensory impairment.

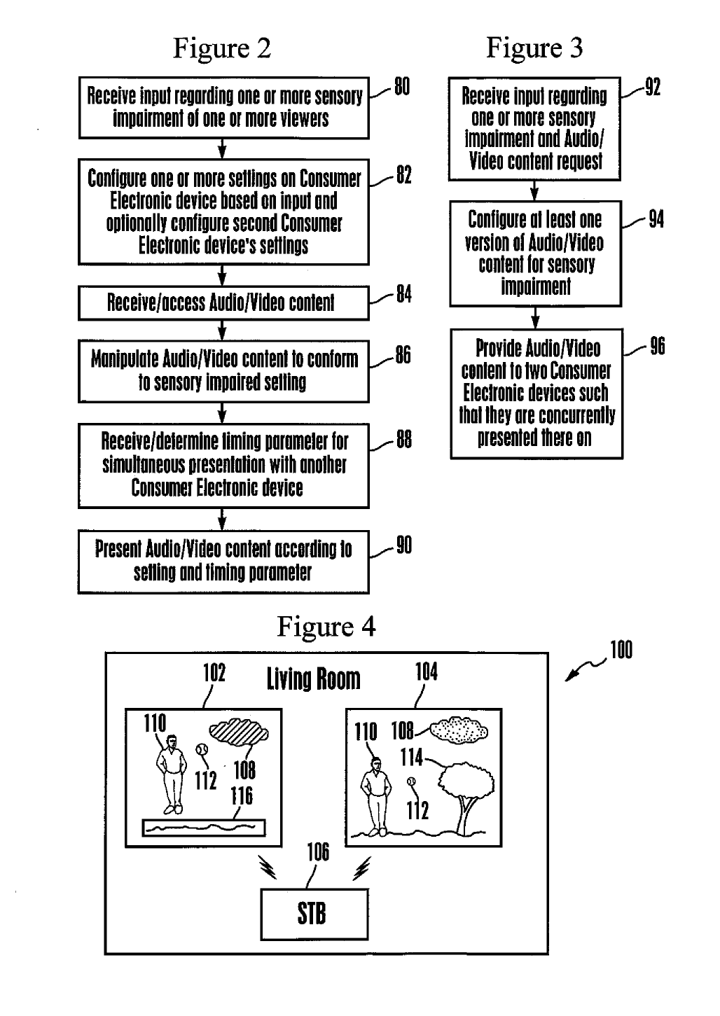

Still in reference to FIG. 1, reference is now made to the server 18. The server 18 includes at least one processor 70, at least one tangible computer readable storage medium 72 such as disk-based or solid state storage, and at least one network interface 74 that, under control of the processor 70, allows for communication with the CE devices 12 and 16 over the network 28 and indeed may facilitate communication therebetween in accordance with present principles. Note that the network interface 74 may be, e.g., a wired or wireless modem or router, or other appropriate interface such as, e.g., a Wi-Fi, Bluetooth, Ethernet or wireless telephony transceiver. Accordingly, in some embodiments the server 18 may be an Internet server, may facilitate AV content coordination and presentation between CE device devices, and may include and perform “cloud” functions such that the CE devices 12 and 16 may access a “cloud” environment via the server 18 in exemplary embodiments, where the cloud stores the AV content to be e.g. presented in normal format on one of the CE devices 12, 16 and in another format for some one with a sensory impairment on the other of the CE devices 12, 16. Note that the processors 30, 46, 66, and 70 are configured to execute logic and/or software code in accordance with the principles set forth herein. Thus, for instance, the processor 30 is understood to be configured at least to execute the logic of FIG. 2 while the processor 70 is understood to be configured at least to execute the logic of FIG. 3.

Turning now to FIG. 2, an exemplary flow chart of logic to be executed by a CE device in accordance with present principles such as, e.g. a computerized TV, set top box, television and integrated receiver, etc. is shown. Beginning at block 80, the logic receives input (e.g. from one or more users via RC manipulation) regarding one or more sensory impairments of one or more of the viewers of the CE device. Such impairments may include e.g. visual impairments such as partial blindness and color blindness, audio impairments such as a hearing impairment, and cognitive impairments such as e.g. the ability to understand spoken words and follow the plot of a show or movie. After the input is received at block 80, the logic moves to block 82 where one or more sensory impairment settings of the CE device are configured based on the input.

Optionally, at block 82 the logic may configure at second CE device's settings as well. Thus, e.g., should the processor executing the logic of FIG. 2 be a set top box, the set top box may configure a ,first CE device such as a TV to present AV content according to a first sensory impairment setting for a first sensory impairment, but then configure another CE device such as a tablet computer to present the same AV content according to a different, second sensory impairment setting for a different, second sensory impairment. In other words, the set top box may configure two devices (and/or a version of the AV content to be presented thereon) differently at block 82 for different sensory impairments based on sensory impairment input received at block 80. Notwithstanding, note that in other embodiments e.g. a TV processor may receive the input at block 80, configure the TV to present AV content according to a first sensory impairment setting for a first sensory impairment, and then configure a tablet computer to present the same AV content according to a different, second sensory impairment setting for a different, second sensory impairment. In still other embodiments, e.g. a network gateway such as a computerized router may undertake the logic of FIG. 2.

In any case, after block 82 the logic proceeds to block 84 where the logic receives or otherwise accesses at least one copy, instance, or version of the AV content in accordance with present principles (e.g., a version unaltered for a sensory impairment). Thereafter the logic moves to block 86 where the logic manipulates one or more copies, instances, and/or versions of the AV content to conform to the one or more sensory impaired settings as indicated at block 80. For example, the logic may e.g. daltonize the AV content to make it more perceptible to a person with partial color-blindness. After manipulating at least one of the copies, instances, or versions of the accessed AV content, the logic proceeds to block 88 where the logic receives and/or determines at least one timing parameter to be utilized by the logic to enable and/or configure the CE devices for simultaneous presentation of the AV content (e.g., one version of the AV content that has been daltonized and will be presented on one CE device may be presented simultaneously or near-simultaneously with another version of the same AV content that has not been daltonized and will be presented on another CE device based on the timing parameter to create a shared-viewing experience). Despite the foregoing, note that in some embodiments the same version, copy, or instance of the AV content may be presentable on each respective CE device, e.g. streamed via multicast Internet Protocol (IP) or IEEE 1394 packets, where the CE device itself manipulates the AV content according to a sensory impairment setting. In other words, the foregoing disclosure of two versions of the same AV content being used is meant to be exemplary and also that the same (e.g. “original” or “normal”) AV content version may be provided to multiple CE devices which is then optimized thereat for one or more sensory impairment in accordance with present principles.

Also in some other embodiments, the first display device (e.g., a TV) forwards the content to the second display device (e.g. a tablet). Thus, the content may be sent from the server to the first device, and the companion display is then “slaved” off of the first device. Control used to trick play content with the first device will also cause content to be trick played on the second device. The first device may process the content for the second device or the content may be streamed with the second display processing the content according to the sensory impairment.

Regardless and describing the timing parameter determined at block 88, the timing parameter that is used to determine e.g. when to provide an AV content stream to two CE devices for simultaneous presentation of the same portions of the AV content at the same time thereon but with different sensory impairment configurations (e.g., minute one, second fifty two of the AV content is presented on both CE devices at the same time) may be based on e.g. residential Wi-Fi network conditions over which the AV content will be provided to the CE devices (such as available bandwidth) and/or any wired connection speed differences such as one Wi-Fi connection for one device and one HDMI connection for another.

In any case, after block 88 at which the one or more timing parameters are determined, the exemplary logic concludes at block 90 where the logic presents and/or configures the CE devices to present the AV content in accordance with the one or more sensory impairment settings according to the at least one timing parameter so that the AV content is presented concurrently on both of the CE devices. Thus, e.g. a shared-viewing experience is created where a person without a sensory impairment may be able to observe the AV content on one of the CE devices in its unaltered form for that user's optimal viewing, while a sensory-impaired person may observe the AV content on another of the CE devices in e.g. daltonized form for the sensory-impaired user's optimal viewing, but in either case both viewers observe the same portion of the AV content concurrently in the same room using two CE devices as if they were both observing the AV content on a single CE device.

Continuing the detailed description in reference to FIG. 3, exemplary logic to be executed by e.g. a content-providing Internet server and/or head end in accordance with present principles is shown. Beginning at block 92, the logic receives input from one or more CE devices regarding one or more sensory impairments of at least one viewer. Also at block 92, the logic receives a request for AV content. The logic then moves to block 94 where the logic configures and/or formats at least one version, instance, and/or copy of the requested AV content according to the sensory impairment(s) indicated in the input that was received at block 92.

The logic then moves to block 96 where it provides e.g. two versions of the same underlying AV content to the CE devices, set top box, etc. such that the two versions of the AV content may be presented simultaneously or near-simultaneously. Notwithstanding the exemplary logic described in reference to FIG. 3, it is to be understood that in some instances e.g. a content-providing server (and/or e.g. the first display device) may instead or additionally receive a request for AV content and then simply provide the AV content in a form or format not tailored to a sensory impairment specifically, and then the AV content may be manipulated by the CE devices, set top box, etc. in accordance with sensory impairment indications input thereto once it has been received by from the server.

Now in reference to FIG. 4, an exemplary diagram 100 of two CE devices 102, 104 and a set top box 106 all located in the same room of a personal residence such as a living room is shown. It is to be understood that the set top box 106 is in communication with the CE devices 102, 104 to provide AV content thereto in accordance with present principles for synchronized, at least near-simultaneous presentation of the AV content on the CE devices. As may be appreciated from FIG. 4, the CE device 102 is presenting a scene from the AV content and the CE device 104 is presenting the same scene (and even e.g. the same specific frame of the AV content) at the same point in the AV content. Contrasting the AV content as presented on the CE devices 102, 104, while the CE device 104 presents the underlying AV content in a format that has not been altered for observance by a person with a sensory impairment, the CE device 102 presents the AV content in a format that has in fact been altered for observance by a person with at least one impairment.

Thus, relative to the AV content as presented on the CE device 104, the content on the CE device 102 in the present exemplary instance is daltonized as may be appreciated from the differing shading of a cloud 108 in the sky to symbolize on the black and white figure that the color presentation of the cloud as presented on the CE device 102 is not the same as it is presented on the CE device 104. As may also be appreciated from FIG. 4, a person 110 and baseball 112 shown in the scene are magnified on the CE device 102 to make the person 110 (e.g. the details of the person's appearance) and baseball 112 more perceptible to a person with a visual impairment. However, note that in some instances when magnifying content in accordance with present principles, the entire frame of the AV content may not be able to be presented (e.g. depending on the display device capabilities). Thus, a tree 114 is presented on the CE device 104 on the right portion of the frame but is not presented on the CE device 102 due to the magnification of objects located more centrally in the frame. Additionally, note that the CE device 102 presents closed captioning box 116, which is understood to present closed-captioning content associated with the scene of the AV content when e.g. a sensory impairment setting for closed captioning, audio or cognitive, has been set to active in accordance with present principles.

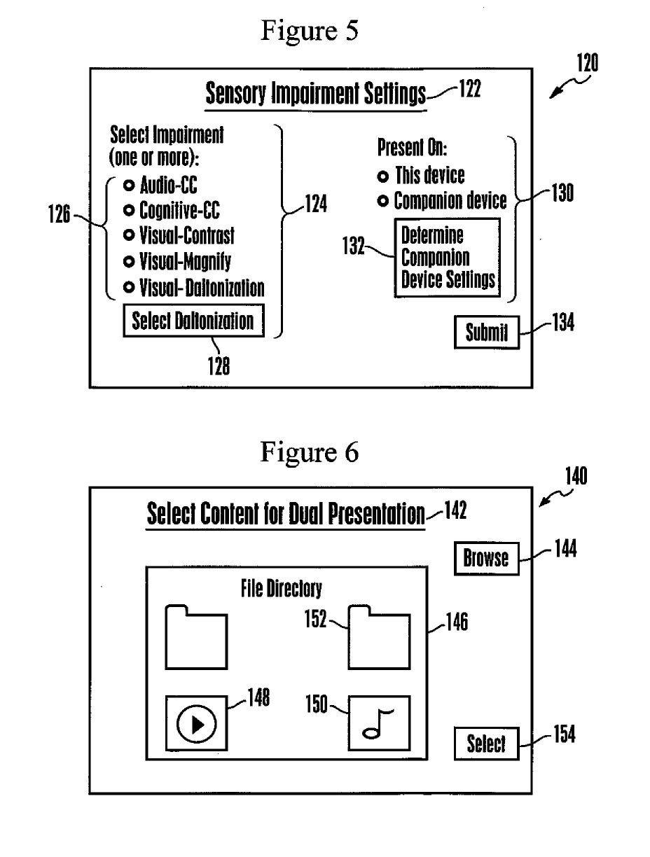

Moving from FIG. 4 to FIG. 5, this figure shows a sensory impairment settings user interface (UI) 120 in accordance with present principles. The settings UI 120 includes a title 122 indicating that the UI pertains to sensory impairment or accessibility settings. The UI 120 also includes a first section 124 for a user to manipulate to select one or more sensory impairments which the user may have and wish that the CE device provide AV content in a format that accommodates the one or more sensory impairments. Thus, five exemplary options 126 are shown, one for an audible impairment that may be configured for presenting spoken words and sounds displayed as closed captioning, another for cognitive impairment that may be configured for presenting descriptive information on the display as closed captioning (e.g. descriptions of the plot (e.g. a synopsis), what the characters are saying, etc.), and three for visual impairments including a setting that when set to active presents AV content in greater contrast, one that magnifies AV content in accordance with present principles, and one that daltonizes the AV content in accordance with present principles. Also note that a selector element 128 indicating that particular daltonization settings may be set is shown. The selector element 128 is thus understood to be selectable to cause e.g. another screen and/or an overlay window to be presented that sets forth various kinds of daltonization that may be used depending on the person's particular color blind condition. Once the particular daltonization is selected, this input may be used by the CE device processor in accordance with present principles.

The UI 120 of FIG. 5 also shows a second section 130 that provides options for which CE device(s) the manipulator of the UI 120 desires that AV content in a sensory-impaired configuration be presented. Thus, one option is provided for presenting such AV content on the device presenting the UI 120, and another option is provided for also or instead presenting such AV content on a companion device e.g. detected as being present in the same location or close thereto by the CE device presenting the UI 120 (e.g. based on network connections, notifications, mutual authentication, etc.). In addition to the foregoing, in some embodiments the section 130 may also include a selector element 132 indicating that companion device (e.g. the other detected device) settings may be determined responsive to selection thereof. Thus, selection of the selector element 132 may cause another UI to be presented or for an overlay window to be presented that includes selectable sensory impaired options that can be set for the companion device that may e.g. be similar to the section 126 described above.

Concluding the description of FIG. 5, a submit selector element 134 is shown at the bottom of the UI 120 that may be selected to set one or more sensory impaired settings to active in accordance with present principles. Further, note that the UI 120 may be incorporated into a larger and/or general CE device setting UI, and/or it may form part of a separate settings UI only for selecting one or more sensory impaired settings for which to view AV content in accordance with present principles.

Moving to FIG. 6, an exemplary UI 140 presentable on a CE device in accordance with present principles for selecting a content for dual presentation on two CE devices in the same location is shown. The UI 140 includes a title 142 indicating that a content can be selected, along with a browse selector element 144 that may be selectable to cause window 146 to be presented. The window 146 may be e.g. a file directory of contents available to the CE device and even e.g. stored on a local storage medium of the CE device. Plural files are shown in the window 146, including an AV content thumbnail 148 with a play symbol thereon to indicate that the underlying content is AV content, a music thumbnail 150 with a musical note thereon to indicate that the underlying content is audio content, and at least one file 152 that may e.g. include plural AV content files and may be selectable to cause the contents of that file to be presented on the UI 140 where the window 146 is presented as shown in FIG. 6. Last, note that a select selector element 154 is shown that is selectable to provide input to the CE device to present a content selected from the window 146.

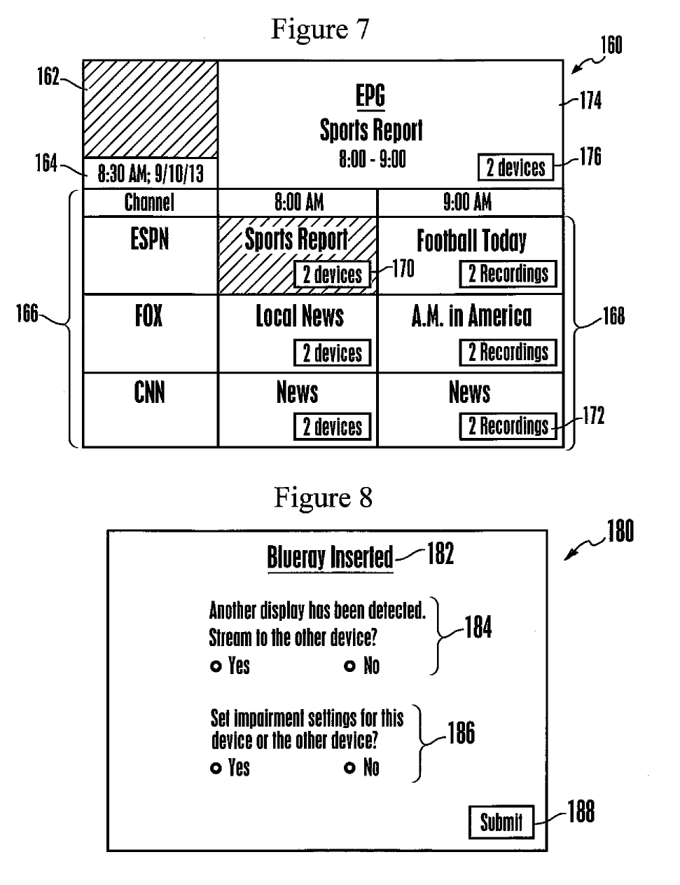

Now in reference to FIG. 7, an exemplary electronic programming guide (EPG) 160 presentable on a CE device such as e.g. a television is shown. The EPG 160 may be used to select e.g. AV content provided (e.g. broadcasted) by e.g. a head end and/or server for presentation on two CE devices in the same location in accordance with present principles. The EPG 160 includes a current content section 162 presenting currently tuned-to content, along with current temporal information 164 including the date and time of day. The EPG 160 also includes a grid section 166 of one or more panels 168 presenting information for respective AV contents associated therewith. For instance, the channel ESPN is presenting the program titled Sports Report at eight a.m., and then the program titled Football Today at nine a.m. Note that at least one of the panels 168 includes a selector element 170 indicating “two devices” which is selectable to cause the AV content associated with the panel on which the selected selector element 170 is presented to be presented on two CE devices in accordance with present principles.

Thus, as one specific example, selection of the selector element 170 may automatically without further user input cause the AV content associated therewith to automatically be presented on two CE devices (e.g. identified as being in proximity to each other, to the set top box, and/or in the same room) that have had their respective CE device sensory impairment settings configured prior to selection of the element 170. Thus, the AV content may be seamlessly presented on two devices responsive to selection of the selector element 170. If, however, the CE devices have not had their respective CE device sensory impairment settings configured prior to selection of the element 170 (or alternatively to automatically presenting the content even if they have had their respective CE device sensory impairment settings configured prior to selection of the element 170), then a settings UI such as the UI 120 may be presented to configure one or more of the CE devices in accordance with present principles.

Still in reference to the UI 160 of FIG. 7, note that another of the panels 168 for a program to be aired and/or provided in the future such as the program on the UI 160 titled “News” for the channel CNN may include a selector element 172 indicating “two recordings” that, rather than automatically presenting the associated AV content responsive to selection of the element since the AV content is not scheduled to be provided until a time later than the current time when the EPG is presented, automatically sets the AV content to record on at least one of the devices and even e.g. both CE devices. Accordingly, the content when recorded may be automatically stored on one or both of the CE devices, and furthermore may e.g. be automatically stored as it is recorded in a format optimized for one or more sensory impairments (e.g. configured in real time as it is recorded to a storage medium of one of the CE devices) based on sensory impairment settings that have been preset by a user for that particular CE device in accordance with present principles (e.g. set prior to selection of the element 172). Thus, if desired, in some embodiments selection of the element 172 may cause two versions and/or copies of the AV content to be recorded on one or more of the CE devices, where one version is an “original” version that has not been altered for more optimal observance by a person with a sensory impairment and one version that is optimized in accordance with present principles for observance by a person with at least one sensory impairment.

Continuing the description of FIG. 7, the UI 160 also includes a detailed information section 174 that shows detailed information for AV content associated with a currently selected and/or highlighted panel 168. In the present exemplary embodiment, the shading of the panel for Sports Report denotes that it is the panel on which a cursor controllable e.g. using a RC is currently positioned on, and hence information associated with the Sports Report is presented on the section 174. Note that should the cursor move to another of the panels, then the section 174 may dynamically change to then present detailed information for the navigated-to panel. In any case, in addition to detailed information for the Sports Report, the exemplary section 174 may also include a selector element 176 that may be substantially similar in function and configuration to the selector element 170, and in other instances when detailed information is presented on the section 174 for content yet to be provided may be substantially similar in function and configuration to the selector element 172.

Moving to FIG. 8, another exemplary UI 180 in accordance with present principles is shown, the UI 180 configured for selecting whether to present AV content on two devices as disclosed herein in response to initiation of a Blu-ray function. Thus, it is to be understood that e.g. responsive to a CE device detecting a Blu-ray function has been initiated such as inserting a disc into a connected, powered on Blu-ray player and without further user action, the UI 180 may be presented on a display of the CE device in accordance with present principles.

As may be appreciated from FIG. 8, the UI 180 includes a title 182 indicating that a Blu-ray disc has been inserted, and also at least a first prompt 184 indicating that another display other than the one presenting the UI 180 has been detected (e.g. and indeed another CE device such as a “companion” device has been detected in accordance with present principles). The prompt 184 thus presents information on whether the user wishes to present the Blu-ray content on the other display that has been detected, and further includes yes and no options that are selectable using the respective radio buttons associated therewith to provide input to the CE device presenting the UI 180 for whether or not to present the Blu-ray content on the other display as well. Accordingly, if the user declines to present the Blu-ray content on the other display by manipulating the UI 180, then the content is only presented on the CE device presenting the UI 180 whereas if the user selects the “yes” selector element then the content may e.g. automatically begin presenting the content on both devices in accordance with present principles once the UI 180 is removed from the display of the CE device.

In addition to the foregoing, the UI 180 also includes another prompt 186 prompting a user regarding whether to set impairment settings for the device presenting the UI 180 and/or the other detected device. The prompt 186 thus includes yes and no options that are selectable using the respective radio buttons associated therewith to provide input to the CE device presenting the UI 180 for whether or not to configure settings for one or both devices. If the user declines to configure settings, then the content may be presented on one or both CE devices (e.g. depending on the user's selection from the prompt 184) whereas if the user provides input (e.g. selecting “yes” on the prompt 186) to configure one or more settings, another UI such as the settings UI 120 of FIG. 5 may be presented to configure one or more sensory impairment settings. Last, note that the UI 180 includes a submit selector element 188 that is selectable to provide the user's selections (e.g. input at the prompts 184, 186) to the CE device processor to cause the processor to (e.g. automatically without further user input) execute one or more functions as just described.

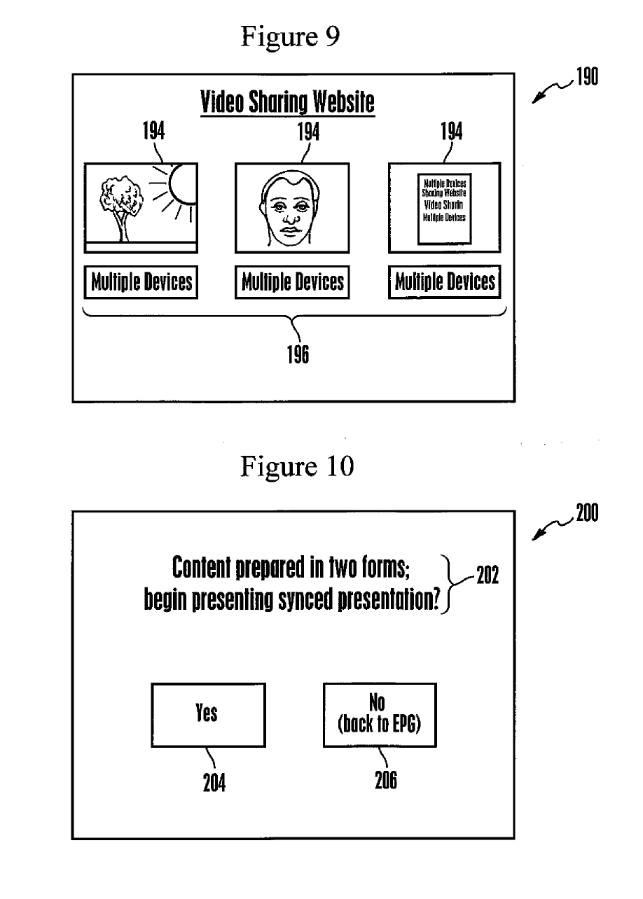

Now in reference to FIG. 9, an exemplary video sharing website UI 190 is shown. Thus, for instance, should a user navigate to a video sharing website on a browser presented on a CE device, the UI 190 may be presented. The UI 190 includes a title 192 indicating that the UI pertains to video sharing, as well as plural thumbnails 194 associated with AV content that when selected cause the AV content associated with the selected thumbnail 194 to be presented on the CE device. Furthermore, the UI 190 includes respective “multiple device” selector elements 196 associated with each thumbnail 194 and hence each AV content available for presentation. Each of the selector elements are understood to be selectable to cause, automatically and without further user input after their selection, the AV content associated with the selected element 196 to be presented on the CE device presenting the UI 190 and another “companion” device in accordance with present principles. In addition and though not shown, note that the prompts 184 and 186 may be presented when selecting content from a video sharing website as described (e.g., selection of a thumbnail 194 may cause at least one of the prompts to be presented), and indeed the prompts 184, 186 may be presented in accordance with the AV content access features described in reference to FIGS. 6 and 7 as well.

Concluding the detailed description in reference to FIG. 10, an exemplary UI 200 is shown containing a prompt 202 that may be presented on a CE device in accordance with present principles when e.g. a user has selected AV content and provided input to the CE device that the AV content should be presented not only on the CE device but also a “companion” device in accordance with present principles. Thus, it is to be understood that the UI 200 is presented after e.g. two versions of the AV content have been configured, where one may be optimized by a person with a sensory impairment. The prompt 202 thus indicates that the content has been prepared in two forms, and also asks whether the user wishes to begin simultaneously presenting the two forms of AV content, one on each of the CE devices as described herein. Thus, a yes selector element 204 is included on the UI 200 that is selectable to cause the two forms to be presented automatically without further user input, as well as a no selector element 206 which is selectable to e.g. decline dual presentation on the CE devices and return to an EPG or another UI from which the AV content was initially selected prior to presentation of the UI 200.

Now with no particular reference to any figure, it is to be understood that in some embodiments e.g., the magnification described above to assist e.g. a visually impaired person with observing a particular portion of presented AV content such as a person presented in an image may include e.g. only magnifying the head of the person, the person as a whole, two or more heads of people engaged in a conversation in the image, etc.

Also in some embodiments, audio impairment settings to be employed in accordance with present principles may include adjusting and/or configuring volume output, pitch and/or frequency on one of the CE devices such as e.g. making volume output on the subject CE device louder than output on the “companion” device and/or louder than a preset or pre-configuration of the AV content. Notwithstanding, it so to also be understood that in other instances to e.g. avoid a “stereo” audio effect the two devices may be configured such that audio is only output from one of the CE devices but not the other even if video of the AV content is presented on both.

It may now be appreciated based on the foregoing that e.g. daltonization of video (such as e.g. enhancing the distinction of green and/or red content) of AV content can assist with the viewing of AV content on a “companion” CE device to e.g. a TV that also presents the content. Additionally, closed captioning and other metadata may be presented on one of the CE devices (e.g. overlaid on a portion of the AV content) to further assist a person with a sensory impairment.

Note also that more than two CE devices may be configured and used in accordance with present principles. Also note that in embodiments where one CE device is a TV and the other is another type of CE device such as a tablet computer, e.g. the TV may present the “normal” content and audio while the tablet may present only video of the AV content that has been optimized for one or more sensory impairments, but also that the opposite may be true in that the TV may present the optimized video while the tablet may presented the “normal” content.

Addressing control of the AV content as it is presented on the two CE devices, note that e.g. if the user wishes to play, pause, stop, fast forward, rewind, etc. the content, the two CE devices may communicate with each other such that e.g. performing the function on one device (e.g. pressing “pause”) may cause that device to not only pause the content on it but also send a command to the other device to pause content such that the two contents are paused simultaneously or near-simultaneously in accordance with present principles to enhance the shared viewing experience of an AV content on two devices. In this respect, e.g. the two CE devices may be said to be “slaved” to each other such that an action occurring at one device occurs on both devices. Note further that e.g. should a set top box (e.g. and/or a home server) be providing the content to both devices, a fast forward command input to the set top box may cause the set top box to control the content as presented on each of the CE devices by causing fast forwarding on each one to appear to occur simultaneously or near simultaneously. Further still and as another example, should the content be paused, fast forwarded, etc. by manipulating a tablet computer “companion” device, gestures in free space recognizable as input by the tablet may be used to control presentation of the AV content on both devices.

As indicated above, AV content may be provided to each of the CE devices on which it is to be presented in a number of ways, with one version of the AV content being optimized for observance by a person with a sensory impairment. For example, a set top box may provide (e.g. stream) the content to each CE device even over different connections (e.g. HDMI for a TV and an IP connection such as Direct WiFi for a tablet computer to also present the content). As other examples, content may be delivered to the devices via the Internet, may be streamed from the Internet to one device and then forwarded to another device where the device receiving the content from the Internet manages the timing of presentation such that the content is presented simultaneously on both devices, may be independently streamed from a server or head end but still simultaneously presented, etc. Furthermore, e.g. in an instance where once device forwards the content to the other CE device, the CE device receiving the forwarded content may parse the content for metadata to then display e.g. closed captioning, magnify the content or at least a portion thereof to show people talking, etc., and/or daltonize a version of the content before forwarding it. Even further, present principles recognize that a content stream that is received by the “companion” device may have the metadata such as closed captioning already composited in the video (e.g. graphics displayed/overlaid on top of the video) as done by the forwarding device at the forwarding device, thus allowing the “companion” device to simply render the video on the screen to also convey the metadata. Also, note that even though closed captioning has been referenced herein, other types of metadata (e.g., displayed as certain type(s) of closed captioning) may be presented/overlaid on video in accordance with present principles such as e.g. plot information regarding the plot of the AV content (e.g. a plot synopsis, scene descriptions and/or scene synopsis, plot narration, etc.) to thus assist a cognitively impaired viewer with following and understanding what is occurring in the AV content.

In addition, e.g. when using a set top box, Internet, and/or a server in accordance with present principles, when providing content to two CE devices the Digital Living Network Alliance (DLNA) standard may be used, as may be e.g. UpNp protocols and W3C either in conjunction with or separately from DLNA standards. Also, e.g., the CE devices (e.g. their respective displays) may act as digital media renderers (DMRs) and/or digital media players (DMPs) and/or digital media control points (DMCs) that may interface with the set top box, the set top box acting as a digital media server (DMS) where e.g. the DMS would ensure that the same content was being streamed to both displays synchronously albeit at least one version of the content being optimized for observance based on a sensory impairment.

While the particular DUAL AUDIO VIDEO OUTPUT DEVICES WITH ONE DEVICE CONFIGURED FOR THE SENSORY IMPAIRED is herein shown and described in detail, it is to be understood that the subject matter which is encompassed by the present invention is limited only by the claims.

What is claimed is:

1. An apparatus comprising:
at least one processor;
at least one computer readable storage medium that is not a carrier wave and that is accessible to the processor, the computer readable storage medium bearing instructions which when executed by the processor cause the processor to:
receive input representing visual, audio and/or cognitive capabilities of a first person;
at least in part based on the input, configure at least a first setting on a first audio video output device;
present a first audio video presentation on the first audio video output device in accordance with the first setting; and
concurrently with presenting the first audio video presentation on the first audio video output device, present the first audio video presentation on a companion audio video output device located in a common space with the first audio video output device.

2. The apparatus of claim 1, wherein the instructions when executed by the processor further cause the processor to:
receive second input representing visual, audio and/or cognitive capabilities of a second person;
at least in part based on the second input, configure at least a second setting on the companion audio video output device; and
present the first audio video presentation on the companion audio video output device in accordance with the second setting.

3. The apparatus of claim 2, wherein the first setting is a visual display setting.

4. The apparatus of claim 3, wherein the first setting is a first visual display setting and the second setting is configured for presenting video from the first audio video presentation in a configuration not optimized for the visually impaired.

5. The apparatus of claim 3, wherein the first setting is a first visual display setting and the second setting is a second visual display different from the first visual display setting, both the first and second visual display settings being configured for presentation of video from the first audio video presentation in configurations optimized for the visually impaired.

6. The apparatus of claim 2, wherein the first setting is a setting for presenting closed captioning or metadata.

7. The apparatus of claim 2, wherein the first setting is a visual display setting for magnifying images presented on the first audio video output device.

8. The apparatus of claim 7, wherein at least one person included in at least one image presented on the first audio video output device is magnified.

9. The apparatus of claim 2, wherein the first setting is an audio setting.

10. The apparatus of claim 9, wherein the first setting pertains to volume output on the first audio video output device.

11. The apparatus of claim 9, wherein the first setting pertains to audio pitch and/or frequency.

12. A method, comprising:
providing audio video (AV) content to at least two AV display devices, wherein the AV content is configured for presentation on a first AV display device according to a first setting configured to optimize the AV content for observance by a person with a sensory impairment;
synchronizing presentation of the AV content on the first AV display device and a second AV display device, presentation of the AV content being synchronized such that at least similar video portions of the AV content are presented on the first and second AV display devices at or around the same time.

13. The method of claim 13, wherein the AV content is configured for presentation on the second AV display device according to a second setting not configured for optimizing the AV content for observance by a person with a sensory impairment.

14. The method of claim 12, wherein the first setting is established at the first AV display device at least in part based on user input representing a sensory impairment.

15. The method of claim 14, wherein the sensory impairment is a visual impairment.

16. The method of claim 14, wherein the first setting is a closed captioning setting that has been set to active.

17. The method of claim 15, wherein the first setting is configured to optimize the AV content for observance by a person with a visual impairment at least in part by daltonizing at least a portion of video of the AV content.

18. The method of claim 12, wherein synchronizing such that at least similar video portions of the AV content are presented on the first and second AV display devices at or around the same time includes presenting the same video portion of the AV content on both the first and second AV devices simultaneously.

19. A computer readable storage medium that is not a carrier wave, the computer readable storage medium bearing instructions which when executed by a processor configure the processor to execute logic comprising:
providing audio video (AV) content to at least one consumer electronics (CE) device, wherein the AV content is configured for presentation on a first CE display device according to a first setting configured to optimize the AV content for observance on the CE device by a person with a sensory impairment;
providing the AV content from the first CE device to a second CE device;
synchronizing presentation of the AV content on the first CE device and the second CE device, presentation of the AV content being synchronized such that at least similar video portions of the AV content are presented on the first and second CE devices at or around the same time.

20. The computer readable storage medium of claim 19, wherein the AV content is optimized by being configured in a daltonized format.
